(19) United States
(12) Patent Application Publication
(10) Pub. No.: US 2002/0191887 A1
(43) Pub. Date: Dec. 19, 2002

(54) Optical circuit and monitoring method

(76) Inventor: Serge Bidnyk, Ottawa (CA)

Correspondence Address: Zenastra Photonics, Inc., 2305 St. Laurent Blvd., Ottawa, ON, K1G 4J8, CA

(21) Appl. No.: 09/884,762

(22) Filed: Jun. 19, 2001

(51) Int. Cl. G02B 6/26; G02B 6/28

(52) U.S. Cl. 385/15; 385/24

(57) ABSTRACT

An optical circuit in which a grating router, such as an arrayed-waveguide grating, multiplexes together optical signals at different wavelengths, and a directional coupler directs a portion of the multiplexed signal back through the grating router to de-multiplex that portion and facilitate monitoring of the multiplexed optical signal at each of the different wavelengths.

### FIELD OF THE INVENTION

This invention relates generally to structures for generating, carrying, and/or processing optical signals.

### BACKGROUND

It is becoming increasingly more common for telecommunication networks to send and receive information as optical signals over fiber optic networks. Such fiber optic networks generally provide significantly greater bandwidth than their electrical wire counterparts. For example, many networks presently use wavelength division multiplexing (WDM) techniques in which a single optical fiber can simultaneously carry multiple signals at different wavelengths.

Such optical networks typically include optical circuits located at, e.g., terminal points or nodes, of the optical network. One such circuit, for example, is a WDM transmitter, which includes multiple sources generating optical signals at different wavelengths, a multiplexer such as an arrayed waveguide grating (AWG) for spatially combining the different optical signals to produce a WDM transmission signal, and waveguides connecting each laser source to the multiplexer. The WDM transmitter may also include one or more optical monitoring loops for real-time monitoring and correcting of the power output from each source.

One such monitoring technique involves positioning a photodetector near the back facet of each source to monitor the respective output based on the leakage through the back facet. Another technique involves positioning a directional coupler (e.g., a Y-junction) along the waveguide connecting each source to the multiplexer to monitor the output power in each wavelength. The latter technique monitors not only fluctuations in the output from each source, but also the coupling efficiency between each source and the waveguide connecting that source to the multiplexer. A third monitoring technique involves tapping a small portion of the WDM output signal and using a WDM power monitor to resolve the respective intensities at the different wavelengths in that portion.

Another type of optical circuit is a WDM transceiver, which complements a WDM transmitter with a WDM receiver. A WDM receiver typically includes a de-multiplexer, e.g., a second AWG, to spatially separate the WDM signal into different wavelengths, and photodetectors to convert the optical signal at each wavelength into an electrical signal.

### SUMMARY

In one aspect, the invention features an optical circuit in which a grating router, such as an AWG, multiplexes together optical signals at different wavelengths, and a directional coupler directs a portion of the multiplexed signal back through the grating router to de-multiplex that portion and facilitate monitoring of the multiplexed optical signal at each of the different wavelengths. In some embodiments, the optical circuit may further include sources for producing the optical signals, and detectors for monitoring the light coupled back through the grating router. In such cases the optical circuit is a transmitter that provides signal generating, multiplexing, and monitoring functions.

In additional embodiments, the grating router in the optical chip is further configured to receive and de-multiplex an incoming WDM signal. The optical chip then sends the de-multiplexed signals to additional detectors for signal detection. In these cases, the optical chip is a transceiver that provides signal generating, multiplexing, monitoring, de-multiplexing, and detecting functions.

The optical circuit can be constructed using components that lend themselves to integration using planar light waveguide circuit (PLC) technology. In particular, for example, an AWG, a laser chip array, a photodiode array, and connecting waveguides can be efficiently integrated on a silicon-based substrate to produce a compact integrated optical chip providing multiple functions.

In general, in one aspect, the invention features an optical monitoring method including: directing optical signals from a plurality of input waveguides through a grating router to an output waveguide; coupling a portion of the optical signals in the output waveguide back to the grating router through a return waveguide; directing the coupled portion of the optical signals from the return waveguide through the grating router to a plurality of detection waveguides; and monitoring at least one property of the optical signal in each of the detection waveguides. The grating router can be, for example, an arrayed-waveguide grating (AWG). Alternatively, the grating router can include, for example, an echelle grating. The number of input waveguides and the number of detection waveguides can each be greater than two.

Embodiments of the method can include any of the following features.

The directing of the optical signals can include multiplexing the optical signals from the plurality of input waveguides to the output waveguide. The directing of the coupled portion can include de-multiplexing the coupled portion of the optical signals from the return waveguide to the plurality of detection waveguides. Accordingly, the optical signals can include multiple signals at different wavelengths.

The plurality of input and detection waveguides can connect to a first end of the grating router, and the output and return waveguides can connect to a second end of the grating router.

The method can further include generating the optical signals, e.g., from an array of sources. Furthermore, the method can further include selecting a particular wavelength for at least one of the optical signals by using a Bragg grating.

The monitoring of the optical signal property in each of the detection waveguides can include directing light from each detection waveguide to one of a plurality of detectors, e.g., a photodetector array. The at least one optical signal property can include at least one of intensity, phase, pulse shape, and polarization. The monitoring of each of the detection waveguides can be indicative of the performance of the grating router. Moreover, the method can further include adjusting at least one property of at least one of the optical signals in the input waveguides based on the monitoring of each of the detection waveguides. For example, the adjustment (such as adjusting output intensity) can be in response to the monitoring of each of the detection waveguides.

The directing of the optical signals, the directing of the coupled portion, and the monitoring of the optical signal property in each of the detection waveguides can be performed in an integrated planar light waveguide circuit. For example, the input waveguides can include a set of adjacent channel waveguides formed in the integrated planar light waveguide circuit. Similarly, the detection waveguides can include a second set of adjacent channel waveguides formed in the integrated planar light waveguide circuit. Furthermore, the coupling of a portion of the optical signals can be performed in the integrated planar light waveguide circuit.

The method can further include directing a second set of optical signals from a reception waveguide through the grating router to a second plurality of detection waveguides, and monitoring at least one property of the optical signal in each of the second plurality of detection waveguides. The directing of the second set of optical signals can include de-multiplexing the second set of optical signals from the reception waveguide to the second plurality of detection waveguides. Accordingly, such embodiments include both transmission and reception of WDM signals.

The plurality of input waveguides, the first plurality of detection waveguides, and the second plurality of detection waveguides can connect to a first end of the grating router, and the output waveguide, return waveguide, and reception waveguide can connect to a second end of the grating router. The monitoring of the optical signal property in each of the first plurality of detection waveguides can include directing light from each of the first plurality of detection waveguides to one of a first plurality of detectors, and the monitoring of the optical signal property in each of the second plurality of detection waveguides can include directing light from each of the second plurality of detection waveguides to one of a second plurality of detectors. For example, the first and second pluralities of detectors can be formed by a photodetector array.

The directing of the first set of optical signals, the directing of the coupled portion, the directing of the second set of optical signals, the monitoring of each of the first plurality of detection waveguides, and the monitoring of each of the second plurality of detection waveguides can be performed in an integrated planar light waveguide circuit. For example, the first and second pluralities of detection waveguides can include an adjacent set of channel waveguides in the integrated planar light waveguide circuit. Furthermore, the coupling of a portion of the optical signals can be performed in the integrated planar light waveguide circuit.

In general, in another aspect, the invention features an optical circuit including: a grating router having first and second ends; a plurality of input waveguides connected to the first end of the grating router; a plurality of detection waveguides connected to one of the first and second ends (e.g., the first end) of the grating router; an output waveguide connected to the second end of the grating router; a return waveguide connected to the other of the first and second ends (e.g., the second end) of the grating router; and a directional coupler positioned to couple a portion of light in the output waveguide back to the grating router through the return waveguide. The grating router can be, for example, an arrayed-waveguide grating (AWG). Alternatively, the grating router can include, for example, an echelle grating. The number of input waveguides and the number of detection waveguides can each be greater than two. During operation, the grating router is configured to multiplex optical signals from the input waveguides to the output waveguide, and de-multiplex a portion of the multiplexed optical signals from the return waveguide to the detection waveguides. Accordingly, the optical signals can include multiple signals at different wavelengths.

Embodiments of the optical circuit can include any of the following features.

The optical circuit can include a light source connected to each of the input waveguides for generating an optical signal in therein. For example, the optical circuit can include a semiconductor laser diode array. Furthermore, at least one of the sources may include a Bragg grating for selecting a particular wavelength for the corresponding optical signal. Moreover, the optical circuit may further including a detector connected to each of the detection waveguides. For example, the detectors can form a photodetector array.

The optical circuit can be integrated into a planar waveguide structure. For example, the input waveguides, detection waveguides, and grating router can be integrated into a planar waveguide integrated circuit, and the input and detection waveguides can be formed as channel waveguides in the planar waveguide integrated circuit. Furthermore, the output waveguide, the return waveguide, and the directional coupler can be integrated into the planar waveguide integrated circuit, and the output and return waveguides are formed as channel waveguides in the planar waveguide integrated circuit. Alternatively, the output waveguide and the return waveguide can be optical fibers.

The optical circuit can further including a reception waveguide connected to the grating router and a second plurality of detection waveguides connected to the grating router. For example, the reception waveguide can be connected to the second end of the grating router and the second plurality of detection waveguides can be connected to first end of the grating router. In such embodiments, the grating router is configured to multiplex a first set of optical signals from the input waveguides to the output waveguide, de-multiplex a portion of the first set optical signals from the return waveguide to the first plurality detection waveguides, and de-multiplex the second set of optical signals from the reception waveguide to the second plurality of detection waveguides. Thus, optical circuit in such embodiments provides both WDM transmission and reception functions. Furthermore, the optical circuit can include a detector array having a detector element coupled to each of the detection waveguides in the first and second pluralities of detection waveguides.

In general, in another aspect, the invention features an integrated planar waveguide transmitter module including: (i) an arrayed-waveguide grating (AWG); (ii) an array of light sources coupled to the AWG by a plurality of adjacent channel waveguides; (iii) an array of photodetectors coupled to the AWG by a second plurality of adjacent channel waveguides; (iv) an output waveguide channel and a return waveguide channel connected to the AWG; and (v) a directional coupler positioned to couple a portion of light in the output waveguide channel back to the AWG through the return waveguide channel. During operation the AWG multiplexes optical signals from the array of sources to the output waveguide channel, and de-multiplexes a portion of the multiplexed optical signals from the return waveguide channel to the array of photodetectors for monitoring.

The module may further include a controller electrically coupled to the light source array and the photodetector array. During operation the controller adjusts the output of the light source array based on the monitoring by the photodetector array.

In general, in another aspect, the invention features an integrated planar waveguide transmitter module including: (i) an arrayed-waveguide grating (AWG); (ii) an array of light sources coupled to the AWG by a plurality of adjacent channel waveguides; (iii) an array of photodetectors coupled to the AWG by a second plurality of adjacent channel waveguides, the array of photodetectors defining first and second sets of photodetectors; (iv) an output waveguide channel, a return waveguide channel, and a reception waveguide channel connected to the AWG; and (v) a directional coupler positioned to couple a portion of light in the output waveguide channel back to the AWG through the return waveguide channel. During operation the AWG multiplexes optical signals from the array of sources to the output waveguide channel, de-multiplexes a portion of the multiplexed optical signals from the return waveguide channel to the first set of photodetectors for monitoring, and de-multiplexes incoming optical signals from the reception fiber to the second set of photodetectors.

The module may further include a controller electrically coupled to the light source array and the photodetector array. During operation the controller adjusts the output of the light source array based on the monitoring by the photodetector array.

Embodiments of the invention may include any of the following advantages.

Because the directional coupler directs a portion of the multiplexed signal back through the grating router (e.g., an AWG) to facilitate monitoring, the detectors monitor the performance of the different wavelength of the multiplexed optical signal at the output of the optical circuit (e.g., the output of the transmitter or transceiver). Thus, the overall performance of the transmitter or transceiver can be monitored rather than only selected components. In particular, the monitored performance can account for the coupling efficiency between the sources and the grating router, as well as performance fluctuations (e.g., intensity fluctuations) in the sources themselves. Furthermore, the monitored performance can account for variations in the intensities of the different wavelengths of the multiplexed optical signal frequency caused by frequency detuning of the sources relative to the grating router. Moreover, the coupling efficiency of the directional coupler is relatively uniform over the monitored signals as compared to the use of multiple directional couplers for separated wavelength channels, which will tend to differ from one another because of manufacturing non-uniformities.

Also, the monitored performance does not suffer from frequency detuning caused by multiplexing the transmitted signal and de-multiplexing a portion of the transmitted signal for monitoring purposes, because the same grating router is used for both functions. Similarly, because the optical circuit only requires one grating router, only one temperature control unit is needed to stabilize the performance of the optical circuit, thereby simplifying corresponding electronic control circuits and reducing power consumption.

Another advantage embodiments may have is that the sources and detectors can be positioned as arrays because the directional coupler may be on the side of the grating router opposite the sources and detectors. Thus, a laser chip array can be used as the sources and a photodetector array can be used as the detectors. As described above, such arrays lend themselves to compact planar integration of the optical circuit. Thus, embodiments include compact integrated optical circuits that provide multiple functions.

Such embodiments are compact not only because they implement arrayed solutions for the active components (e.g., the sources and detectors), but also because they require only a single grating router and a single directional coupler to provide the multiple functions. Such size reduction allows multiple devices to be fabricated on a single wafer. Moreover, the number of channels supported by the optical chip module (e.g., a transmitter or transceiver optical chip) can scale to large numbers simply by scaling up the number of channels supported by the grating router component and the detector and source array components.

Other features, objects, and advantages of the invention will be apparent from the following detailed description and drawings, and from the claims.

### DESCRIPTION OF DRAWINGS

The invention will now be further described merely by way of example with reference to the accompanying drawings in which:

FIG. 1 is a schematic diagram of 4-channel transmitter architecture for WDM;

FIG. 2 is a schematic diagram of 4-channel transceiver (4-channel transmitter and 4-channel receiver) architecture.

Like reference symbols in the various drawings indicate like elements.

### DETAILED DESCRIPTION

The invention features optical circuit modules such as a WDM optical transmitter and a WDM optical transceiver. In the detailed embodiments that follow, the optical circuits include an arrayed waveguide grating (AWG) to perform multiplexing and/or demultiplexing functions. An AWG includes two multiport couplers (e.g., star couplers) interconnected by an array of waveguides having varying lengths. The varying lengths are selected to constructively recombine certain wavelengths, and not others, at specified spatial locations at the output of the AWG. By exploiting this principle of constructive and destructive optical interference, an AWG can be constructed to perform a wide range of multiplexing and de-multiplexing operations. See, e.g., R. Ramaswami and K. N. Sivarajan in Optical Networks, at pp. 112-115, Morgan Kaufmann Publishers, Inc., San Francisco, 1998.

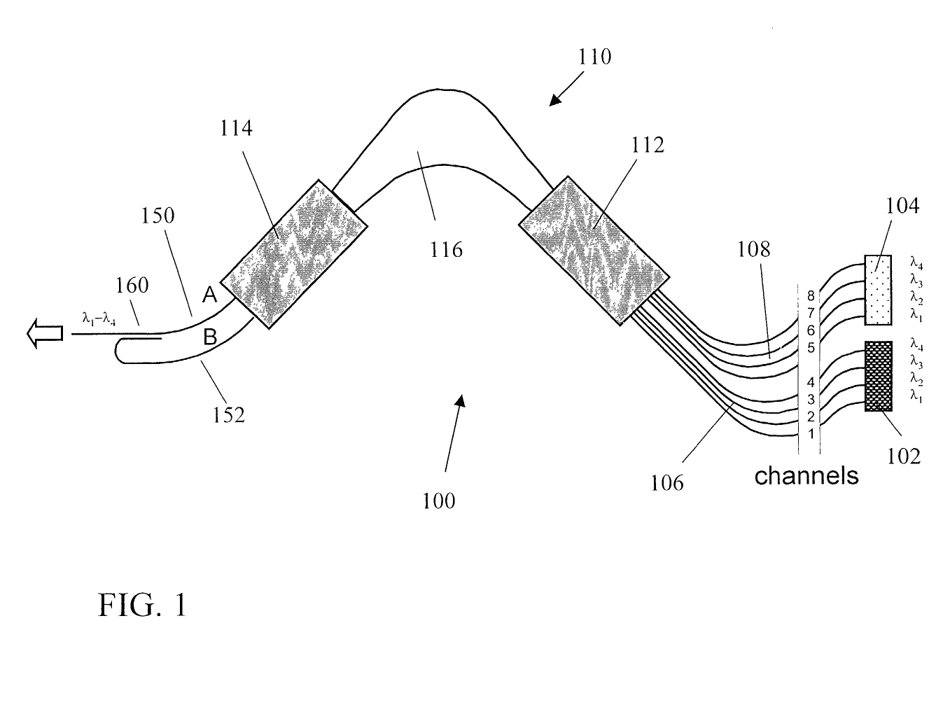

One such optical circuit is the integrated four-channel optical transmitter 100 shown in FIG. 1. Transmitter 100 is formed on a silicon-based substrate (not shown) and includes a semiconductor laser array 102 providing an array of sources, a photodiode array 104 providing an array of detectors, and an arrayed waveguide grating (AWG) 110. To accommodate the four channels of the transmitter, AWG 110 is selected to be a 2×8 AWG. It includes first and second star couplers 112 and 114 on opposite sides of arrayed waveguides 116. Waveguide channels 106 and 108 connect laser array 102 and detector array 104, respectively, to star coupler 112. As shown in FIG. 1, the waveguide channels define 8 input channels (ch. 1, ch. 2, ch. 3, ch. 4, ch. 5, ch. 6, ch. 7, ch. 8) for AWG 110. Star coupler 114 defines two output ports (A and B) for AWG 110. The optical circuit is formed using hybrid-integration of planar lightwave circuit (PLC) technology (e.g., to form the AWG and channel waveguides) with semiconductor laser/detector chip arrays.

In the presently defined embodiment, AWG 110 is constructed to meet the following requirements. When input channels 1, 2, 3, and 4 receive optical signals at wavelengths λ₁, λ₂, λ₃, and λ₄ respectively, (i.e., λ₃→ch. 1, λ₂→ch. 2, λ₃→ch. 3, and λ₄→ch. 4), AWG 110 multiplexes those signals together at port A. In the other hand, when input channels 5, 6, 7, and 8 receive optical signals at wavelengths λ₁,λ₂, λ₃, and λ₄, respectively, (i.e., λ₁→ch. 5, λ₂→ch. 6, λ₃→ch. 7, and λ₄→ch. 8), AWG 110 multiplexes those signals together at port B. Conversely, when AWG 110 is used in reverse and port B receives a WDM signal carrying multiple signals at wavelengths λ₁, λ₃, and λ₄, AWG 110 de-multiplexes those signals to input channels 5, 6, 7, and 8, respectively, (i.e., ch. 5 (λ₁), ch. 6 (λ₂), ch. 7 (λ₃), and ch. 8 (λ₄)).

Accordingly, each source in laser array 102 provides a signal at a different one of wavelengths λ₁, λ₂, λ₃ and λ₄ and directs that signal to star coupler 112 through the corresponding channel waveguide. Thereafter, AWG 110 multiplexes the signals together at port A to produce a four-channel multiplexed transmission signal. An output fiber 150 connected to port A then carries the transmission signal to downstream applications.

In the presently described embodiment, source array 102 is a semiconductor laser array. In additional embodiments, different types of sources can be used, such as, for example, fiber lasers, distributed feedback lasers, and light-emitting diodes. Whatever the particular type of source, each source can be selected to generate a particular one of the wavelengths desired in the WDM transmission signal. Alternatively, in other embodiments, an array of identical sources can be used, and Bragg gratings can be formed in the waveguides connecting the sources to the AWG to provide the desired wavelength selectivity. In such cases, each source generates gain in a wide spectral range, and the corresponding Bragg grating provides optical feedback for only the selected wavelength, thereby causing the laser to operate at the selected wavelength. In other words, each Bragg grating functions as an end mirror for the corresponding laser. Such embodiments simplify the design of the laser array and increase the stability of the channel wavelengths.

A controller (not shown) is electrically coupled to laser array 102 and independently controls the signal intensity of each wavelength in the transmission signal. To monitor the signal intensity at each of the wavelengths, a directional coupler 160 taps a small portion of the transmission signal in fiber 150 and redirects it via fiber 152 to port B. AWG 110 then de-multiplexes wavelengths λ₁, λ₂, λ₃, and λ₄ in the portion to channels 5, 6, 7, and 8, respectively, where channel waveguides 108 direct the de-multiplexed wavelengths to detector array 104 to independently measure the respective signal intensities. The controller is also electrically coupled to detector array 104, and can include logic and/or a user interface to independently modify the transmission properties of each laser source based on the detector array measurements. For example, the measurements can provide a feedback loop for laser drivers and establish monitoring, dynamic gain equalizing, and stabilizing functions for the laser array.

Notably, in the presently described embodiment, a directional coupler is positioned at the output of the transmitter module to tap all wavelengths. Thus, every wavelength is monitored. The portion tapped by the directional coupler provides an accurate sample of the multiplexed transmission signal because variations in the coupling efficiency of a single coupler is generally small across the spectral range of WDM channels. Furthermore, the monitoring arrangement accounts for intensity variations caused by every component in the transmitter through to the output (e.g., the sources, coupling efficiency between the sources and the channel waveguides, detuning between the laser frequencies and the AWG channels, etc.). This is in contrast to, for example, back or front facet monitoring of the laser sources themselves.

Furthermore, the transmitter is compact because it requires only one directional coupler and one AWG to accomplish multi-channel WDM transmission and monitoring. Also, because the directional coupler is on the side of the AWG opposite the sources and detectors, all of the channel waveguides connecting the sources to the AWG can be adjacent one another. Similarly, all of the channel waveguides connecting the AWG to the detectors can be adjacent one another. Such adjacent channel waveguides minimize bends that can cause loss, minimize the layout of the optical circuit, and facilitate the use of laser and detector arrays, which further reduces the size and integration complexity of the transmitter.

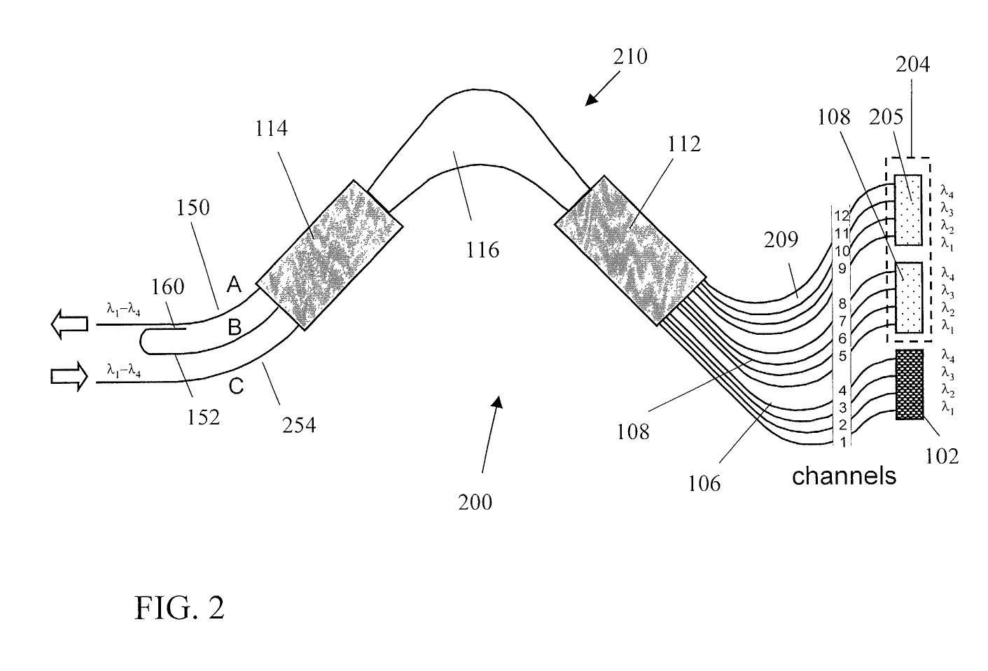

In another embodiment, transmitter 100 can be modified to form an integrated four-channel optical transceiver 200, as shown in FIG. 2. Transceiver 200 includes many of the same elements as those in transmitter 100. However, to further accommodate receiving a four-channel WDM signal, the AWG in transceiver 200 is a 3×12 AWG 210, rather than 2×8 AWG 110. Transceiver 200 also includes an additional detector array 205 and waveguide channels 209 connecting detectors in array 205 to AWG 210.

The first 8 channels of AWG 210 (ch. 1 to ch. 8) and ports A and B are designed to function identically to those of AWG 110 described previously. Channels 9, 10, 11, and 12 and port C are chosen such that when wavelengths λ₁, λ₂, λ₃ and λ₄ enter through port C, they are de-multiplexed by AWG 210 at channels 9 to 12 (λ₁→ch. 9, λ₂→ch. 10, λ₃→ch. 11, and λ₄→ch. 12). Corresponding detectors 205 then convert the de-multiplexed signals into electrical signals for measurement. Accordingly, channels 9-12 are used to detect the multiplexed signals of an incoming WDM signal at port C to provide the receiving function for transceiver 200. An optical fiber 254 carries that WDM signal to port C. Collectively, the transceiver architecture demonstrated by transceiver 200 in FIG. 2 combines a single AWG and a single directional coupler with source and detector arrays to provide both WDM transmitter and receiver functions with dynamic gain equalizing and channel performance monitoring functions.

Furthermore, because waveguide channels 5 to 12 are all adjacent, detector arrays 104 and 205 can be formed from a single detector array 204, which detects the signal in all eight channels (ch. 5 to ch. 12). Thus, both receiver and monitoring functions can be achieved with a single active array. Furthermore, one AWG is used for multiplexing the transmission signals, de-multiplexing the monitoring signal, and de-multiplexing an incoming WDM signal, thereby by simplifying the transceiver architecture. Moreover, because only one AWG is required, only one temperature controller is required for the entire transceiver module, thereby simplifying electronics and reducing overall power consumption.

Each detector in detector array 104 can be any detector suitable for monitoring the desired performance property of the WDM transmission signal. For example, the detectors can be an array of photodiodes, such as PIN, MSM, or avalanche photodiodes (APD), with various response times (from millisecond to subpicosecond).

Although the embodiments of the transmitter and transceiver described above have four channels, the underlying architecture scales to any number of channels simply by increasing the channels in each of the underlying components. For example, an N-channel transmitter (or transceiver) can be constructed in the same manner as that described above with reference to FIG. 1 (or FIG. 2 for the transceiver) by using a 2×2N AWG (or a 3×3N AWG for the transceiver), an N-channel laser source array, an N-channel detector array (or a 2N-channel detector array for the transceiver), and a corresponding number of waveguide is channels connecting the sources and detectors to the AWG. Indeed, one of the advantages of the architecture is that it can scale in this straightforward manner without increasing the number of underlying components, thereby simplifying integration into a monolithic structure. Thus, other embodiments of the transmitter and transceiver include those involving a number of channels different from four, e.g., greater than four.

In the embodiments described above, the transmitter (and transceiver) is constructed as an integrated planar waveguide module having optical WDM ports A and B (ports A, B, and C for the transceiver) for coupling to corresponding optical fibers. As described above, multi-channel monitoring is accomplished by using directional coupler 160 to tap a portion of the WDM signal from output fiber 150 connected to port A and directing that portion to port B using optical fiber 152. Such a directional coupler can be formed, for example, by fusing the two optical fibers together over a coupling length corresponding to the desired tapping proportion. For the transceiver module, port C is used to receive an incoming WDM signal carried by a third optical fiber.

In other embodiments of the transmitter and transceiver, however, directional coupler 160 is integrated into the planar waveguide module. In such embodiments, fibers 150 and 152 are replaced with channel waveguides formed in the planar waveguide module, and the directional coupler is formed by coupling the two waveguide channels together over a length corresponding to the desired tapping proportion. The resulting module can include a downstream output port following the directional coupler for coupling the monitored transmission signal to an output fiber. Alternatively, the transmitter or transceiver module can be integrated into a larger monolithic structure together with one or more additional optical circuit structures. In such cases, the waveguide channel carrying the transmitted WDM signal continues onto some subsequent portion of the larger integrated circuit structure. Similarly, for the case of the transceiver, a waveguide channel carries the incoming WDM signal to the AWG from some other portion of the larger integrated circuit structure.

On the other hand, although the architecture described herein lends itself to integrated planar light waveguide circuits, further embodiments of the invention include optical circuits where optical fibers connect the sources and/or the detectors to the AWG, rather than channel waveguides. Similarly, although source arrays and detector arrays lend themselves to planar integration, other embodiments of the invention include those where separated sources and/or detectors are used.

Furthermore, in other embodiments, the positions of the return waveguide (e.g., fiber 152 or the corresponding channel waveguide) and the waveguides connecting the AWG to detector array for monitoring (e.g., channel waveguides 108) can be reversed. Thus, the return waveguide receives a portion of the transmission signal from the output waveguide and directs that portion to the source side of the AWG, and the AWG demultiplexes that portion to detection waveguides on the output waveguide side of the AWG. Accordingly, for the case of the 4-channel transmitter (or 4-channel tranceiver), the AWG is now constructed as a 5×5 AWG (or a 6×9 AWG for the case of the transceiver). Similarly, in the transceiver, the positions of the reception waveguide (e.g., fiber 254 or the corresponding channel waveguide) and the waveguides connecting the AWG to the detector array for receiving (e.g., channel waveguides 209) can be reversed, with a corresponding change in the AWG construction. Preferably, however, the detection waveguides for monitoring and receiving are on the same side of the AWG so that a single detector array can be used for both.

In the embodiments described above, detector array 104 and related processing electronics measured the intensity of the different wavelengths in the sampled portion of the WDM transmission. In other embodiments, however, another or additional properties of the optical signal can be monitored. In general, the detectors and related processing electronics can be used to monitor one or more properties of the optical signal at the different wavelengths. Such properties include intensity, phase, polarization, pulse shape, and bit rate, among others. Any of these monitored properties can be used to guide feedback or control loops in the electronic controller used to control the output of the laser sources.

Finally, all of the embodiments described in this section so far involve an AWG as the multiplexer/de-multiplexer. An AWG is a specific example of a grating router. Generally, a grating router is a device that provides multiplexing, de-multiplexing, and routing functions using a dispersive element, such as the arrayed waveguides in the AWG. Other embodiments of the invention may employ other types of grating routers as the multiplexer/de-multiplexer. For example, the multiplexer/de-multiplexer can be based on an echelle grating. In one such embodiment, the echelle-grating-based grating router includes an echelle grating etched into one end of a two-dimensional (2D) waveguide. During a de-multiplexing operation, WDM light from a channel waveguide is allowed to diverge within the 2D-waveguide until it reaches the echelle grating. The echelle grating then diffracts the light as a function of wavelength and focuses the angularly separated wavelengths onto corresponding channel waveguides at another end of the 2D-waveguide. The shape of the two-dimensional waveguide and/or the alignment of the channel waveguides may be configured to optimize the coupling efficiency between the 2D-waveguide and the channel waveguides. Using additional channel waveguides, multiplexing and routing operations function similarly to those of an AWG.

A number of embodiments of the invention have been described. Nevertheless, it will be understood that various modifications may be made without departing from the spirit and scope of the invention. Accordingly, other embodiments are within the scope of the following claims.

What is claimed is:

1. An optical monitoring method comprising:
directing optical signals from a plurality of input waveguides through a grating router to an output waveguide;
coupling a portion of the optical signals in the output waveguide back to the grating router through a return waveguide;
directing the coupled portion of the optical signals from the return waveguide through the grating router to a plurality of detection waveguides; and
monitoring at least one property of the optical signal in each of the detection waveguides.

2. The method of claim 1, wherein the directing of the optical signals comprises multiplexing the optical signals from the plurality of input waveguides to the output waveguide.

3. The method of claim 1, wherein the directing of the coupled portion comprises de-multiplexing the coupled portion of the optical signals from the return waveguide to the plurality of detection waveguides.

4. The method of claim 1, wherein the plurality of input and detection waveguides connect to a first end of the grating router, and the output and return waveguides connect to a second end of the grating router grating.

5. The method of claim 1, wherein the optical signals comprise multiple signals at different wavelengths.

6. The method of claim 1, further comprising generating the optical signals.

7. The method of claim 6, wherein the optical signals are generated from an array of sources.

8. The method of claim 7, further comprising selecting a particular wavelength for at least one of the optical signals by using a Bragg grating.

9. The method of claim 1, wherein the monitoring of the optical signal property in each of the detection waveguides comprises directing light from each detection waveguide to one of a plurality of detectors.

10. The method of claim 9, wherein the plurality of detectors form a photodetector array.

11. The method of claim 1, further comprising directing a second set of optical signals from a reception waveguide through the grating router to a second plurality of detection waveguides, and monitoring at least one property of the optical signal in each of the second plurality of detection waveguides.

12. The method of claim 11, wherein the directing of the second set of optical signals comprises de-multiplexing the second set of optical signals from the reception waveguide to the second plurality of detection waveguides.

13. The method of claim 11, wherein the plurality of input waveguides, the first plurality of detection waveguides, and the second plurality of detection waveguides connect to a first end of the grating router, and the output waveguide, return waveguide, and reception waveguide connect to a second end of the grating router.

14. The method of claim 11, wherein the second set of optical signals comprises multiple signals at different wavelengths.

15. The method of claim 11, wherein the monitoring of the optical signal property in each of the first plurality of detection waveguides comprises directing light from each of the first plurality of detection waveguides to one of a first plurality of detectors, and wherein the monitoring of the optical signal property in each of the second plurality of detection waveguides comprises directing light from each of the second plurality of detection waveguides to one of a second plurality of detectors.

16. The method of claim 15, wherein the first and second pluralities of detectors are formed by a photodetector array.

17. The method of claim 1, wherein the directing of the optical signals, the directing of the coupled portion, and the monitoring of the optical signal property in each of the detection waveguides are performed in an integrated planar light waveguide circuit.

18. The method of claim 17, wherein the coupling of a portion of the optical signals is performed in the integrated planar light waveguide circuit.

19. The method of claim 11, wherein the directing of the first set of optical signals, the directing of the coupled portion, the directing of the second set of optical signals, the monitoring of each of the first plurality of detection waveguides, and the monitoring of each of the second plurality of detection waveguides are performed in an integrated planar light waveguide circuit.

20. The method of claim 19, wherein the coupling of a portion of the optical signals is performed in the integrated planar light waveguide circuit.

21. The method of claim 17, wherein the input waveguides comprise a set of adjacent channel waveguides formed in the integrated planar light waveguide circuit.

22. The method of claim 21, wherein the detection waveguides comprise a second set of adjacent channel waveguides formed in the integrated planar light waveguide circuit.

23. The method of claim 19, wherein the first and second pluralities of detection waveguides comprise an adjacent set of channel waveguides in the integrated planar light waveguide circuit.

24. The method of claim 1, wherein the number of input waveguides is greater than two, and the number of detection waveguides is greater than two.

25. The method of claim 1, wherein the at least one optical signal property comprises optical signal intensity.

26. The method of claim 1, wherein the at least one signal property comprises at least one of intensity, phase, pulse shape, and polarization.

27. The method of claim 1, wherein the monitoring of each of the detection waveguides is indicative of the performance of the grating router.

28. The method of claim 1, further comprising adjusting at least one property of at least one of the optical signals in the input waveguides based on the monitoring of each of the detection waveguides.

29. The method of claim 28, wherein the adjustment is in response to the monitoring of each of the detection waveguides.

30. The method of claim 28, wherein the adjusted property is intensity.

31. The method of claim 1, wherein the grating router is an arrayed-waveguide grating (AWG).

32. The method of claim 1, wherein the grating router comprises arrayed waveguides.

33. The method of claim 1, wherein the grating router comprises an echelle grating.

34. An optical circuit comprising:
a grating router having first and second ends;
a plurality of input waveguides connected to the first end of the grating router;
a plurality of detection waveguides connected to one of the first and second ends of the grating router;
an output waveguide connected to the second end of the grating router;
a return waveguide connected to the other of the first and second ends of the grating router; and
a directional coupler positioned to couple a portion of light in the output waveguide back to the grating router through the return waveguide.

35. The optical circuit of claim 34, wherein the plurality of detection waveguides is connected to the first end of the grating router and the return waveguide is connected to the second end of the grating router.

36. The optical circuit of claim 34, wherein the grating router is configured to multiplex optical signals from the input waveguides to the output waveguide, and de-multiplex a portion of the multiplexed optical signals from the return waveguide to the detection waveguides.

37. The optical circuit of claim 36, wherein the optical signals comprise multiple signals at different wavelengths.

38. The optical circuit of claim 34, further comprising a light source connected to each of the input waveguides for generating an optical signal in the input waveguide.

39. The optical circuit of claim 38, wherein the light sources comprise a semiconductor laser diode array.

40. The optical circuit of claim 38, wherein at least one of the sources includes a Bragg grating for selecting a particular wavelength for the corresponding optical signal.

41. The optical circuit of claim 38, further comprising a detector connected to each of the detection waveguides.

42. The optical circuit of claim 41, wherein the detectors form a photodetector array.

43. The optical circuit of claim 34, further comprising a reception waveguide connected to the grating router and a second plurality of detection waveguides connected to the grating router.

44. The optical circuit of claim 43, wherein the reception waveguide is connected to the second end of the grating router and the second plurality of detection waveguides is connected to first end of the grating router.

45. The optical circuit of claim 43, wherein the grating router is configured to multiplex a first set of optical signals from the input waveguides to the output waveguide, de-multiplex a portion of the first set optical signals from the return waveguide to the first plurality detection waveguides, and de-multiplex the second set of optical signals from the reception waveguide to the second plurality of detection waveguides.

46. The optical circuit of claim 45, further comprising a detector array having a detector element coupled to each of the detection waveguides in the first and second pluralities of detection waveguides.

47. The optical circuit of claim 34, wherein the input waveguides, detection waveguides, and grating router are integrated into a planar waveguide integrated circuit, and the input and detection waveguides are formed as channel waveguides in the planar waveguide integrated circuit.

48. The optical circuit of claim 47, wherein the output waveguide, the return waveguide, and the directional coupler are integrated into the planar waveguide integrated circuit, and the output and return waveguides are formed as channel waveguides in the planar waveguide integrated circuit.

49. The optical circuit of claim 47, wherein the output waveguide and the return waveguide are optical fibers.

50. The optical circuit of claim 34, wherein the number of input waveguides is greater than two, and the number of detection waveguides is greater than two.

51. An integrated planar waveguide transmitter module comprising:
an arrayed-waveguide grating (AWG);
an array of light sources coupled to the AWG by a plurality of adjacent channel waveguides;
an array of photodetectors coupled to the AWG by a second plurality of adjacent channel waveguides;
an output waveguide channel and a return waveguide channel connected to the AWG; and
a directional coupler positioned to couple a portion of light in the output waveguide channel back to the AWG through the return waveguide channel,
wherein during operation the AWG multiplexes optical signals from the array of sources to the output waveguide channel, and de-multiplexes a portion of the multiplexed optical signals from the return waveguide channel to the array of photodetectors for monitoring.

52. The integrated planar waveguide transmitter module of claim 51, further comprising a controller electrically coupled to the light source array and the photodetector array, wherein during operation the controller adjusts the output of the light source array based on the monitoring by the photodetector array.

53. An integrated planar waveguide transmitter module comprising:
an arrayed-waveguide grating (AWG);
an array of light sources coupled to the AWG by a plurality of adjacent channel waveguides;
an array of photodetectors coupled to the AWG by a second plurality of adjacent channel waveguides, the array of photodetectors defining first and second sets of photodetectors;
an output waveguide channel, a return waveguide channel, and a reception waveguide channel connected to the AWG; and
a directional coupler positioned to couple a portion of light in the output waveguide channel back to the AWG through the return waveguide channel,
wherein during operation the AWG multiplexes optical signals from the array of sources to the output waveguide channel, de-multiplexes a portion of the multiplexed optical signals from the return waveguide channel to the first set of photodetectors for monitoring, and de-multiplexes incoming optical signals from the reception fiber to the second set of photodetectors.

54. The integrated planar waveguide transmitter module of claim 53, further comprising a controller electrically coupled to the light source array and the photodetector array, wherein during operation the controller adjusts the output of the light source array based on the monitoring by the photodetector array.
